(19) United States
(12) Patent Application Publication
(10) Pub. No.: US 2012/0265713 A1
(43) Pub. Date: Oct. 18, 2012

(54) SYSTEM AND METHOD FOR ADVERTISING PRODUCTS

(76) Inventors: Dong Eon KIM, Seoul (KR); Yong Ki Hong, Seoul (KR); Sang Hyuk Choi, Seoul (KR)

(21) Appl. No.: 13/272,487

(22) Filed: Oct. 13, 2011

(30) Foreign Application Priority Data
Apr. 14, 2011 (KR) 10-2011-0034757

(51) Int. Cl. G06Q 30/02; G09F 19/00; G09F 5/00

(52) U.S. Cl. 705/500; 40/1

(57) ABSTRACT

A system for advertising a product includes a transparent display, a stage, and a control unit. The transparent display includes a plurality of pixels and has transmissivity of light that varies depending on a voltage applied to each of the pixels. The stage is arranged at the rear of the transparent display, on which a product is mounted. The control unit controls the transparent display to have the product seen through the transparent display and information about the product displayed on the transparent display.

### CROSS-REFERENCE TO RELATED PATENT APPLICATIONS

This application claims the benefit of Korean Patent Application No. 10-2011-0034757, filed on Apr. 14, 2011, in the Korean Intellectual Property Office, the disclosure of which is incorporated herein in its entirety by reference.

### BACKGROUND OF THE INVENTION

1. Field of the Invention

The present invention relates to a system and a method for advertising products using a transparent display.

2. Description of the Related Art

As consumer market grows and develops in various ways, product advertisement has become important. Advertisement may increase sales of products by galvanizing the provoking spending desire. For the product advertisement, and to help consumers choose products, a variety of methods for providing consumers with information about products have been developed. One of the methods is to display or exhibit products. In general, products are displayed or exhibited to be seen through a glass window. Also, various pieces of information of a product may be provided by means of, for example, a quick response (QR) code. A kiosk may be used as one of the product advertisement methods. A kiosk is an information delivery system using a touch screen and may be installed at a public place so that a lot of persons may obtain information about a product through the kiosk. In the kiosk, however, there is a limitation in that persons may not see actual products, but see those in pictures.

### SUMMARY OF THE INVENTION

To solve the above and/or other problems, the present invention provides a system for advertising products, which may provide product information with actual products.

The present invention provides a system for advertising products which may effectively display actual product with product information.

According to an aspect of the present invention, a system for advertising a product includes a transparent display including a plurality of pixels and having transmissivity of light that varies depending on a voltage applied to each of the pixels, a stage arranged at the rear of the transparent display, on which a product is mounted, and a control unit controlling the transparent display to have the product seen through the transparent display and information about the product displayed on the transparent display.

The stage may include a plurality of sub-stages sectioned by at least one partition wall, and the product may be mounted on each of the plurality of sub-stages.

The stage may include a plurality of sub-stages capable of moving, and the product may be mounted on each of the plurality of sub-stages.

The system may further include a driving unit that moves the plurality of sub-stages.

The control unit, in synchronism with the driving unit, may control the transparent display to have information corresponding to the product mounted on each of the plurality of sub-stages displayed on the transparent display.

The control unit may control the transparent display to have information corresponding to the product mounted on each of the plurality of sub-stages displayed on the transparent display while the stage is stopped.

The control unit may control the transparent display to be in a black mode in which light is prevented from passing through the transparent display while the stage is moved.

The transparent display may include a touch screen through which a command is input by contact.

The transparent display may include an automatic mode in which product information is automatically changed every predetermined time and a manual mode in which the product information is manually changed by an external input.

The manual mode may include a plurality of product menus.

The system may further include a face recognition sensor.

The system may further include a computer for collecting information sensed by the face recognition sensor.

The information sensed by the face recognition sensor may include at least one of information about gender and information about age.

The computer may include group information about at least one of age groups and gender groups and product information matched with the group information.

The computer may transmit to the control unit product information matched with group information corresponding to the information sensed by the face recognition sensor, and the control unit may display the matched product information on the transparent display.

According to another aspect of the present invention, a method of advertising a product includes mounting a product on a stage located behind a transparent display, showing the product through the transparent display, and displaying information corresponding to the product on the transparent display by a control unit.

### BRIEF DESCRIPTION OF THE DRAWINGS

The above and other features and advantages of the present invention will become more apparent by describing in detail exemplary embodiments thereof with reference to the attached drawings in which:

FIG. 1 schematically illustrates a product advertisement system according to an embodiment of the present invention;

FIG. 2 is a schematic plan view of a product advertisement system according to another embodiment of the present invention;

FIG. 3 is a schematic plan view of a product advertisement system according to another embodiment of the present invention;

FIG. 4 is a front view of the product advertisement system of FIG. 3;

FIG. 5 is a flowchart for explaining a product advertisement method according to an embodiment of the present invention;

FIG. 6 schematically illustrates a product advertisement system according to another embodiment of the present invention;

FIG. 7 is a flowchart for explaining a product advertisement method according to another embodiment of the present invention;

FIG. 8 schematically illustrates a product advertisement system according to another embodiment of the present invention; and

FIG. 9 is a flowchart for explaining a product advertisement method according to another embodiment of the present invention.

### DETAILED DESCRIPTION OF THE INVENTION

Hereinafter, the present invention will be described in detail by explaining exemplary embodiments of the invention with reference to the attached drawings. Like reference numerals in the drawings denote like elements. Also, the thickness or size of each layer illustrated in the drawings is exaggerated for convenience of explanation and clarity. Also, the terms such as “on” or “above” may be construed to denote that an element may be directly on the other element, arranged off from the other element without contacting, or arranged above the other element with an intervening element(s) therebetween.

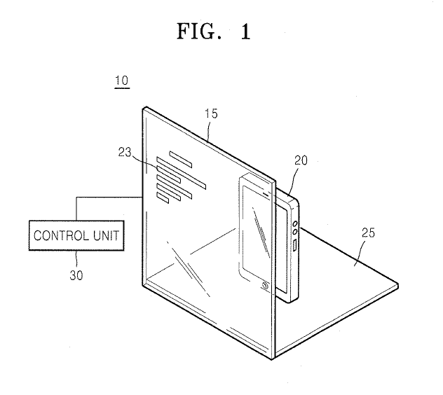

FIG. 1 schematically illustrates a product advertisement system 10 according to an embodiment of the present invention. The product advertisement system 10 may include a transparent display 15 and a stage 25 arranged at the rear of the transparent display 15. A product 20 is mounted on the stage 25 and may be seen through the transparent display 15. The transparent display 15 is formed of transparent members so that an object located behind the transparent display 15 may be seen. Also, the transparent display 15 includes a plurality of pixels and transmissivity of light may be controlled for each pixel so that an image may be displayed. At least one 23 of information about the product 20 and an image related to the product 20 may be displayed on the transparent display 15. The transparent display 15 may include, for example, a transparent liquid crystal display (LCD) or a transparent organic light emitting diode (OLED). Since the transparent display is a well-known technology, a detailed description thereof will be omitted herein. Also, a control unit 30 may control the transparent display 15 by inputting an image signal to the transparent display 15 so that an image is displayed on the transparent display 15 according to the input image signal. To increase a degree of transparency of the transparent display 15, illumination such as a fluorescent lamp or a light emitting diode (LED) may be installed around the transparent display 15.

The product advertisement system 10 according to the present embodiment has a superior advertisement effect because product information may be seen together with the product 20 in real through the transparent display 15. That is, actually seeing the product 20 may stimulate curiosity of users. Providing the product information through the transparent display 15 may help the users choose products.

A product advertisement method according to the present embodiment includes operations of mounting the product 20 on the stage 25 located at the rear of the transparent display 15 and displaying the product 20 through the transparent display 15. The information 23 corresponding to the product 20 is displayed on the transparent display 15 by the control unit 30. Thus, a user may view the product 20 in real while simultaneously seeing information about the product 20.

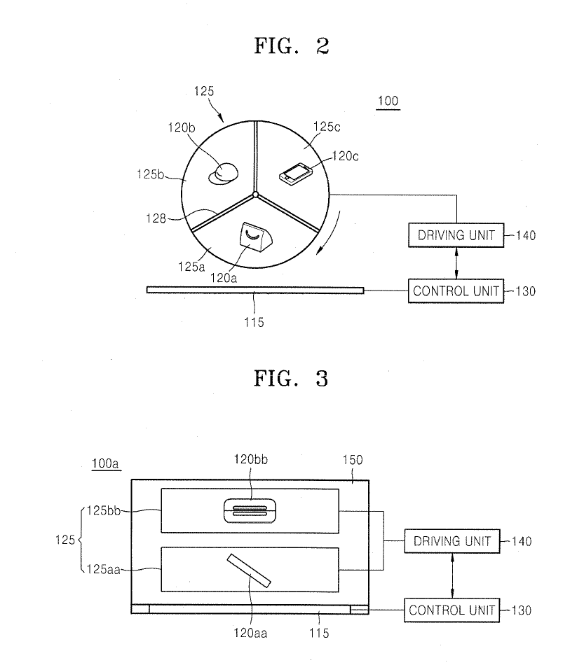

FIG. 2 is a schematic plan view of a product advertisement system 100 according to another embodiment of the present invention. Referring to FIG. 2, the product advertisement system 100 may include a transparent display 115 and a stage 125 where a product is mounted. The stage 125 is arranged at the rear of the transparent display 115 so that the product mounted on the stage 125 may be seen through the transparent display 115. The stage 125 may include a plurality of sub-stages sectioned by at least one partition wall 128. The stage 125 may include first through third sub-stages 125a, 125b, and 125c sectioned by, for example, three partition walls 128. The first through third sub-stages 125a, 125b, and 125c may be respectively put on the first through third products 120a, 120b, and 120c. The first through third products 120a, 120b, and 120c may be different products, for example, a handbag, a hat, a cellular phone, etc. The stage 125 is rotatable so that, as the stage 125 rotates, the products arranged on the respective sub-stages may be sequentially seen through the transparent display 115. A driving unit 140 may be provided to rotate the stage 125. The driving unit 140 may include a motor for rotating the stage 125, for example, a stepping motor that rotates by a predetermined angle according to an applied pulse. The driving unit 140 may control a rotation speed of the stage 125. The driving unit 140 may move the product placed on each of the first through third sub-stages 125a, 125b, and 125c to a position where the product may be seen through the transparent display 115 and stop the stage 125 for a predetermined time. When the product is located at the position where the product may be seen through the transparent display 115, product information corresponding to the product may be displayed on the transparent display 115.

Although in FIG. 2 the stage 125 is illustrated to be circular, the present invention is not limited thereto. A variety of modifications are available only if the modification enables effective display of a product. Also, the number of the sub-stages may be variously changed.

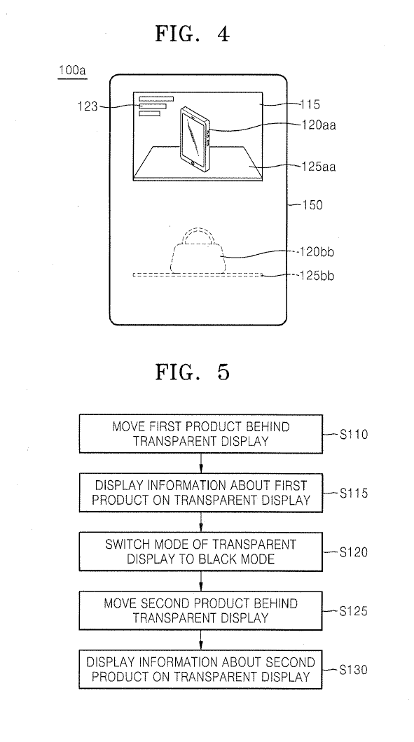

Although FIG. 2 illustrates that the stage 125 is rotatable, a mechanism for moving the stage 125 may be embodied in various ways. As another example, the stage 125 may be movable up and down as illustrated in FIGS. 3 and 4. In a product advertisement system 100a illustrated in FIG. 3, the stage 125 is arranged in a main body 150 and the stage 125 may include a plurality of sub-stages capable of moving up and down. The sub-stages may be, for example, a first sub-stage 125aa and a second sub-stage 125bb on which a first product 120aa and a second product 120bb are respectively placed. The first sub-stage 125aa and the second sub-stage 125bb may be arranged in order behind the transparent display 115.

Referring to FIG. 4, the main body 150 may have an empty box shape. The transparent display 115 is located in an upper portion of the main body 150, while the inside of a lower portion of the main body 150 is not seen due to the main body 150. For example, when the first sub-stage 125aa is located in the upper portion of the main body 150, the first product 120aa placed on the first sub-stage 125aa may be seen from the outside through the transparent display 115. When the second sub-stage 125bb is located in the lower portion of the main body 150, the second product 120bb placed on the second sub-stage 125bb may not be seen from the outside through the transparent display 115. When the first sub-stage 125aa is moved to the lower portion and second sub-stage 125bb is moved to the upper portion, the first product 120aa may not be seen from the outside, whereas the second product 120bb may be seen from the outside through the transparent display 115. In addition, the sub-stages may be movable left and right or back and forth.

A control unit 130 may be provided to control the transparent display 115. The control unit 130 may input an image signal to the transparent display 115 and have product information 123 displayed according to the image signal. The control unit 130 may have the product information 123 corresponding to each of the products displayed in synchronism with the driving unit 140. For example, when the first product 120a or 120aa is located directly behind the transparent display 115, product information about the first product 120a or 120aa may be displayed on the transparent display 115. When the second product 120b or 120bb is located directly behind the transparent display 115 as the stage 125 is moved, product information about the second product 120b or 120bb may be displayed on the transparent display 115. The product advertisement systems 100 and 100a illustrated in FIGS. 2 and 3 have a merit of advertising various products together by moving the stage 125. Also, since related products are continuously displayed in a signal space, space may be saved and product sales promotion may be facilitated.

FIG. 5 is a flowchart for explaining a product advertisement method according to an embodiment of the present invention. The product advertisement method is described with reference to the product advertisement systems 100 and 100a. The driving unit 140 moves the first product 120a or 120aa to be located behind the transparent display 115 (S110). The control unit 130 in synchronism with the driving unit 140 has the product information of the first product 120a or 120aa displayed on the transparent display 115 (S115). The stage 125 is stopped for a predetermined time, during which the product information of the first product 120a or 120aa is displayed on the transparent display 115. Next, the stage 125 is moved so that the second product 120b or 120bb is located behind the transparent display 115 (S125), the control unit 130 inputs an image signal to have the product information of the second product 120b or 120bb displayed on the transparent display 115 (S130). The above process may be identically applied to a case of the third product 120c.

While the stage 125 is moved, the transparent display 115 in a mode of displaying product information or an image may be switched to a black mode in which light is prevented from passing through the transparent display 115 (S120). In the black mode, transmissivity of each pixel of the transparent display 115 is lowered so as to prevent light from passing through the transparent display 115, thereby turning the transparent display 115 in black. Since the backside of the transparent display 115 is not seen in the black mode, the moving of the stage 125 may not be seen from the outside. Since the switching from one product to another according to the movement of the stage 125 is processed in the black mode, a curtain effect as if a curtain falls and then rises during the switching between sub-stages may be obtained. Alternatively, by gradually changing the transparent display 115 to black from a part to the entire surface thereof, another image effect may be obtained. Therefore, by processing the above switching between sub-stages in the black mode or using other image process, a switch to a new product may be effectively performed.

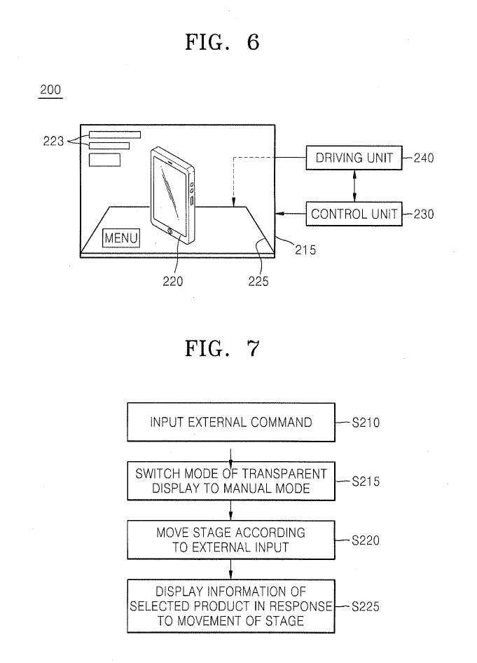

Next, a transparent display of a product advertisement system according to another embodiment of the present invention may include an automatic mode in which product information is automatically changed every predetermined time and a manual mode in which product information is manually changed by an external input. The transparent display operates in the automatic mode until there is an external input. The external input may be made by, for example, a keyboard, a touch screen for inputting commands by touching a screen, etc. The touch screen may operate in any one of a resistive method, a capacitive method, an infrared (IR) method, etc. FIG. 6 schematically illustrates a transparent display 215 including a touch screen operating according to a touch by a user. In an automatic mode, the stage 225 is moved by a driving unit 240 at a predetermined cycle. A control unit 230 controls to have information 223 or an image of a corresponding product displayed on the transparent display 215 in response to a movement of the stage 225. Since the movement of a stage and the display of product information in an automatic mode are substantially the same as those described with reference to FIGS. 2 and 3, detailed descriptions thereof will be omitted herein.

Referring to FIG. 7, when an external command is input to the transparent display 215 (S210). The control unit 230 switches a mode of the transparent display 215 from an automatic mode to a manual mode (S215). In the manual mode, the stage 225 may be moved according to an external input (S220). When the mode is switched from the automatic mode to the manual mode, the movement of the stage 225 is stopped and may be in a ready state until the external input is completed. In the ready state, for example, a plurality of product menus may be displayed on the transparent display 215. When one of the product menus is selected, the control unit 230 controls the driving unit 240 to move a sub-stage where a selected product is placed at a position directly behind the transparent display 215. While the driving unit 240 moved the stage 225, the transparent display 215 may be turned in a black mode as described above. In addition to the black mode, another image may be displayed on the transparent display 215 during the movement of the stage 225.

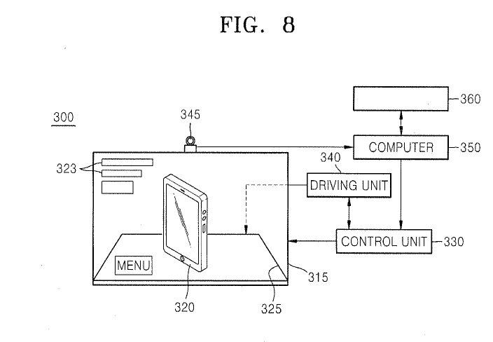

When the selected product is located at a position directly behind the transparent display 215, the control unit 230 controls the information or image about the selected product to be displayed on the transparent display 215 (S225). Accordingly, as the transparent display 215 is switched to the manual mode according to the external input, a user may selectively see a desired product and information so that user convenience may be improved. A product menu in the manual mode may include a menu for selecting information in detail compared to the product information in the automatic mode. FIG. 8 schematically illustrates a product advertisement system 300 according to another embodiment of the present invention. Referring to FIG. 8, the product advertisement system 300 may include a transparent display 315 and a stage 325 arranged at the rear of the transparent display 315. The stage 325 may include a plurality of sub-stages (not shown) that are movable. Since the sub-stages are substantially the same as those described above with reference to FIGS. 2 and 3, detailed descriptions thereof will be omitted herein. The product advertisement system 300 includes a control unit 330 for controlling input of an image signal to the transparent display 315 and a driving unit 340 capable of moving the stage 325. The control unit 330 may control the driving unit 340.

The product advertisement system 300 may further include a face recognition sensor 345 for recognizing a face of a person. The face recognition sensor 345 may be arranged at a position where faces of persons located in front of the transparent display 315 may be well recognized. The face recognition sensor 345 may include a camera (not shown) inside and recognize a face of a person from an image captured by the camera. The face recognition sensor 345 may obtain various pieces of information from the face of a person. The information obtained by the face recognition sensor 345 may include, for example, at least one of information about gender and information about age.

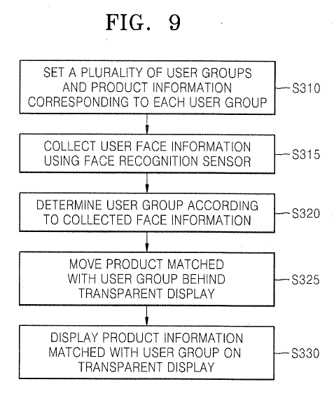

The product advertisement system 300 may further include a computer 350 for collecting information sensed by the face recognition sensor 345. FIG. 9 is a flowchart for explaining a product advertisement method using the product advertisement system 300 of FIG. 8. Referring to FIG. 9, the computer 350 may include data obtained by matching a group of users divided by various characteristics of the users and a product corresponding to the group. That is, a plurality of user groups and product information corresponding to each user group are set (S310). For example, the computer 350 may include a lookup table in which at least one of age groups and gender groups is matched with a product corresponding to the at least one group. A matched product may be, for example, a product preferred by the age group or the gender group.

The computer 350 collects information about a face of a user using the face recognition sensor 345 (S315). A user group corresponding to the collected face information is determined (S320). Data of a product matched to the determined user group is transmitted to the control unit 330. The control unit 330 moves the stage 325 by controlling the driving unit 340 according to the data of the matched product. The driving unit 340 moves the stage 325 such that the matched product can be located behind the transparent display 315 (S325). The control unit 330 controls information or an image 323 of the matched product to be displayed on the transparent display 315 (S330).

When a user approaches the transparent display 315, the face recognition sensor 345 obtains information by recognizing a face of the user and transmits the information to the computer 350. For example, when the information about the user obtained by the face recognition sensor 345 shows that the user is on her twenties, the computer 350 transmits data about a product matched to a group of women on her twenties to the control unit 330. The control unit 330 controls the driving unit 340 to have the matched product, for example, cosmetics for women, located directly behind the transparent display 315. The control unit 330 controls information or an image about cosmetics for women to be displayed on the transparent display 315.

When a plurality of users approach the transparent display 315, a group taking the highest portion in the group information obtained from the face recognition sensor 345 and a product matching the group may be selected. As a result, customized advertisement may be provided to a customer.

A host computer 360 for collecting data transmitted from the face recognition sensor 345 to the computer 350 may be further provided. The host computer 360 may provide advertisers with materials about an advertisement effect or product preference through the accumulated data.

As described above, in the product advertisement system according to the present invention, since a customer can directly see an actual product through a transparent display, the customer may be more interested and an advertisement effect may be improved. Also, since information and/or an image about a product are presented together with a product, customers may be helped a lot in their decision. In addition, since many products are sequentially or selectively presented in a single space, and information about the product is given at the same time, an advertisement space may be efficiently utilized. Further, since related products are continuously presented in a single space, an advertisement effect of the products may be improved much.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A system for advertising a product, the system comprising:
a transparent display comprising a plurality of pixels and having transmissivity of light that varies depending on a voltage applied to each of the pixels;
a stage arranged at the rear of the transparent display, on which a product is mounted; and
a control unit controlling the transparent display to have the product seen through the transparent display and information about the product displayed on the transparent display.

2. The system of claim 1, wherein the stage comprises a plurality of sub-stages sectioned by at least one partition wall, and the product is mounted on each of the plurality of sub-stages.

3. The system of claim 1, wherein the stage comprises a plurality of sub-stages capable of moving, and the product is mounted on each of the plurality of sub-stages.

4. The system of claim 2, further comprising a driving unit that moves the plurality of sub-stages.

5. The system of claim 4, wherein the control unit, in synchronism with the driving unit, controls the transparent display to have information corresponding to the product mounted on each of the plurality of sub-stages displayed on the transparent display.

6. The system of claim 4, wherein the control unit controls the transparent display to have information corresponding to the product mounted on each of the plurality of sub-stages displayed on the transparent display while the stage is stopped.

7. The system of claim 4, wherein the control unit controls the transparent display to be in a black mode in which light is prevented from passing through the transparent display while the stage is moved.

8. The system of claim 1, wherein the transparent display comprises a touch screen through which a command is input by contact.

9. The system of claim 1, wherein the transparent display comprises an automatic mode in which product information is automatically changed every predetermined time and a manual mode in which the product information is manually changed by an external input.

10. The system of claim 9, wherein the manual mode comprises a plurality of product menus.

11. The system of claim 1, further comprising a face recognition sensor.

12. The system of claim 11, further comprising a computer for collecting information sensed by the face recognition sensor.

13. The system of claim 12, wherein the information sensed by the face recognition sensor comprises at least one of information about gender and information about age.

14. The system of claim 12, wherein the computer comprises group information about at least one of age groups and gender groups and product information matched with the group information.

15. The system of claim 14, wherein the computer transmits to the control unit product information matched with group information corresponding to the information sensed by the face recognition sensor, and the control unit displays the matched product information on the transparent display.

16. A method of advertising a product, the method comprising
mounting a product on a stage located behind a transparent display;
showing the product through the transparent display; and
displaying information corresponding to the product on the transparent display by a control unit.

17. The method of claim 16, wherein the stage comprises a plurality of sub-stages sectioned by at least one partition wall, and the product is mounted on each of the plurality of sub-stages.

18. The method of claim 17, further comprising moving the stage using a driving unit.

19. The method of claim 18, wherein information corresponding to the product mounted on each of the plurality of sub-stages is displayed on the transparent display in synchronism with the driving unit.

20. The method of claim 18, wherein information corresponding to the product mounted on each of the plurality of sub-stages is displayed on the transparent display while the stage is stopped.

21. The method of claim 18, wherein the control unit controls the transparent display to prevent light from passing through the transparent display while the stage moves.

22. The method of claim 16, wherein the transparent display comprises a touch screen through which a command is input by contact.

23. The method of claim 16, wherein the transparent display comprises an automatic mode in which product information is automatically changed every predetermined time and a manual mode in which the product information is manually changed by an external input.

24. The method of claim 23, wherein the manual mode comprises a plurality of product menus.

25. The method of claim 16, further comprising recognizing a face of a user using a face recognition sensor.

26. The method of claim 25, further comprising collecting information sensed by the face recognition sensor using a computer.

27. The method of claim 26, wherein the information sensed by the face recognition sensor comprises at least one of information about gender and information about age.

28. The method of claim 26, wherein the computer comprises group information about at least one of age groups and gender groups and product information matched with the group information.

29. The method of claim 26, wherein the computer transmits to the control unit product information matched with group information corresponding to the information sensed by the face recognition sensor, and the control unit displays the matched product information on the transparent display.
